(19) United States
(12) Patent Application Publication
(10) Pub. No.: US 2014/0161034 A1
(43) Pub. Date: Jun. 12, 2014

(54) CARRIER WITH CONFIGURABLE DOWNLINK CONTROL REGION

(71) Applicant: RENESAS MOBILE CORPORATION, Chiyoda-Ku, Tokyo (JP)

(72) Inventors: Jing Han, Beijing (CN); Wei Bai, Beijing (CN); Haiming Wang, Beijing (CN); Na Wei, Beijing (CN); Chunyan Gao, Beijing (CN); Hong Wei, Beijing (CN)

(73) Assignee: RENESAS MOBILE CORPORATION, Chiyoda-Ku, Tokyo (JP)

(21) Appl. No.: 13/985,886

(22) PCT Filed: Feb. 17, 2011
(86) PCT No.: PCT/CN2011/071045

§ 371 Date: Feb. 26, 2014

(51) Int. Cl. H04L 5/00

(52) U.S. Cl. CPC H04L 5/0037
USPC 370/328

(57) ABSTRACT

A first carrier of a carrier aggregation system has a downlink control region DCR which is selectively enabled and disabled. For the case the DCR of the first carrier is disabled, a DCR of a second carrier is used to cross-schedule a user equipment for radio resources on the first carrier. In various embodiments: the DCR of the first carrier lies within an unlicensed radio frequency band; the DCR of the first carrier is disabled by signaling which reduces to zero a number of symbols reserved for the DCR and is enabled by signaling which increases from zero a number of symbols reserved for the DCR; the signaling is downlink and group-based to a plurality of user equipments. The group-based signaling may be a broadcast system information block or a group RNTI, either of which give frequency information of the DCR and an enabled/disabled status indication.

### TECHNICAL FIELD

The exemplary and non-limiting embodiments of this invention relate generally to wireless communication systems, methods, devices and computer programs, and more specifically relate to control channels of a component carrier within a carrier aggregation system.

### BACKGROUND

The following abbreviations that may be found in the specification and/or the drawing figures are defined as follows:
3GPP third generation partnership project
CA carrier aggregation
CC component carrier
C-DCR configurable downlink control region
CE control element
CFI control format indicator
CP cyclic prefix
DL downlink
eNB node B/base station in an E-UTRAN system
E-UTRAN evolved UTRAN (LTE)
HARQ hybrid automatic repeat request
ISM industrial, scientific, medical
LTE long term evolution
LTE-A LTE-Advanced
MAC medium access control
PCFICH physical control format indicator channel
PHICH physical HARQ indicator channel
PDCCH physical downlink control channel
PDSCH physical downlink shared channel
RNTI radio network temporary identifier
RRC radio resource control
SI/SIB system information/system information block
UE user equipment
UL uplink
UTRAN universal terrestrial radio access network

Some of the changes in LTE Release 10 wireless protocol over previous releases include DL and UL MIMO, enhanced use of relays, bandwidth extensions via carrier aggregation and enhanced inter-cell interference coordination. Carrier aggregation CA is relevant to these teachings and concerns multiple component carriers which are aggregated to encompass the whole system bandwidth. By example, in Release 10 the system bandwidth is 100 MHz and the component carriers in one non-limiting implementation may each span 20 MHz. Any given UE compatible with Release 10 is to be configured with one primary CC or Pcell and possibly also one or more secondary CCs or Scells.

During earlier discussions for standardizing CA in Release 10 the concept of cross-scheduling was considered, in which a UE's resource allocation sent on the PDCCH of one CC (typically the Pcell for reliability) scheduled the UE for radio resources which lay in another CC (typically one of the Scells). Current understanding for Release 10 is that all of the CCs will be backwards compatible with Release 8, meaning every CC must have its own PDCCH since the legacy Release 8 UEs will be unable to be cross-scheduled. In practice this means each CC will always have one or more symbols reserved for a DL control channel.

The idea of CCs which are not backwards compatible remains attractive, in that such an extension carrier or carrier segment can enable quite high data rates by using cross-scheduling from another CC to dispense with its own DL control channel and instead utilizing those symbols for user data. Discussions for Release 10 considered that a large number of cross-scheduled UEs or a large number of Scells being cross-scheduled would results in control signaling overhead on the Pcell being too high (multiple PDCCHs on one Pcell for one UE). It was anticipated this would impede efficient scheduling in Release 10, and thereby undermine the data rate and quality of service which cross-scheduling hoped to achieve.

Specifics for an extension carrier which has no downlink control channel region of its own and therefore relies on cross-scheduling of radio resources on that extension carrier may be seen at document R1-093507 by NTT DOCOMO entitled VIEWS ON COMPONENT CARRIER TYPES FOR CARRIER AGGREGATION IN LTE-ADVANCED (3GPP TSG RAN WG1 Meeting #58; Shenzen, China; 24-28 Aug. 2009); R1-093764 by Alcatel-Lucent, Alcatel-Lucent Shanghai Bell entitled COMPONENT CARRIER TYPES IN LTE-A (3GPP TSG RAN WG1 Meeting #58bis; Miyazaki, Japan; 12-16 October 2009); and R4-100453 by TSG RAN WG1 entitled REPLY TO LS ON ADDITIONAL CARRIER TYPES FOR LTE-A (3GPP TSG RAN WG4 Meeting #54; San Francisco, USA; 22-26 Feb. 2010). Further details concerning CA for LTE may be seen at 3GPP TS 36.211 v10.0.0, PHYSICAL CHANNELS AND MODULATION (2010.12); and 3GPP TS 36.331 v10.0.0, RADIO RESOURCE CONTROL (2010.12).

From the inventors' perspective, the problems of high control signaling overhead and cross-scheduling bottlenecks still remain unresolved even if implementation of an extension carrier with no DL control channel is delayed until Release 11. These teachings are directed to addressing that congestion problem.

### SUMMARY

In a first exemplary embodiment of the invention there is an apparatus comprising at least one processor and at least one memory storing a computer program. In this embodiment the at least one memory with the computer program is configured with the at least one processor to cause the apparatus to at least: selectively enable and disable a downlink control region of a first carrier of a carrier aggregation system; and for the case in which the downlink control region of the first carrier is disabled, utilize a downlink control region of a second carrier of the carrier aggregation system to cross-schedule a user equipment for radio resources on the first carrier.

In a second exemplary embodiment of the invention there is a method comprising: selectively enabling and disabling a downlink control region of a first carrier of a carrier aggregation system; and for the case in which the downlink control region of the first carrier is disabled, utilizing a downlink control region of a second carrier of the carrier aggregation system to cross-schedule a user equipment for radio resources on the first carrier

In a third exemplary embodiment of the invention there is a computer readable memory storing a computer program, in which the computer program comprises: code for selectively enabling and disabling a downlink control region of a first carrier of a carrier aggregation system; and code for utilizing a downlink control region of a second carrier of the carrier aggregation system to cross-schedule a user equipment for radio resources on the first carrier for the case in which the downlink control region of the first carrier is disabled.

These and other embodiments and aspects are detailed below with particularity.

### BRIEF DESCRIPTION OF THE DRAWINGS

FIG. 1A is a prior art definition of a cross carrier scheduling configuration information element, reproduced from page 157 of 3GPP TS 36.331 v10.0.0, RADIO RESOURCE CONTROL (2010.12).

FIG. 1B is a timing versus frequency diagram for two user equipments and illustrating delay and wasted radio resources if conventional LTE Release 10 signaling were extended to enable and disable a configurable downlink control region.

FIG. 2 is a flow diagram illustrating actions by an eNB and a UE when a configurable downlink control region carrier is configured according to an exemplary embodiment.

FIG. 3 is a schematic diagram illustrating where an eNB broadcasts a status indication to change a configurable downlink control region from between enabled and disabled according to an exemplary embodiment.

FIG. 4A is a newly defined information element for broadcasting in system information for groups signaling of downlink control region status changes according to an exemplary embodiment of the invention.

FIG. 4B illustrates an exemplary addition to scheduling information for the new information element of FIG. 4A in SIB-laccording to an exemplary embodiment of the invention.

FIG. 4C is a flow diagram similar to FIG. 2 but specifically utilizing the broadcast system information of FIG. 4A according to an exemplary embodiment.

FIG. 5A illustrates a table of RNTI values in which one is reserved for a configurable downlink control region group of UEs according to an exemplary embodiment.

FIG. 5B illustrates a three-byte control element carrying status and frequency of a configurable downlink control region for being scrambled using the reserved RNTI of FIG. 5A, according to an embodiment of the invention.

FIG. 6 is a flow diagram similar to FIG. 2 but specifically utilizing the groups RNTI of FIG. 5A according to an exemplary embodiment.

FIG. 7 is a logic flow diagram that illustrates the operation of a method, and a result of execution of computer program instructions embodied on a computer readable memory, in accordance with the exemplary embodiments of this invention.

FIG. 8 is a simplified block diagram of the UE in communication with a wireless network illustrated as an eNB and a serving gateway SGW, which are exemplary electronic devices suitable for use in practicing the exemplary embodiments of this invention.

### DETAILED DESCRIPTION

The background section above may be considered as describing a conventional CC which has its own PDCCH for scheduling radio resources on that same CC, and an idealized extension carrier which has no PDCCH of its own and so relies on its radio resources being cross-scheduled from another CC. Exemplary embodiments of this invention hybridize those two to achieve a CC with a configurable PDCCH, or more generally a configurable downlink control region, in which configurable means the CC may have a downlink control region or not at the network operator's choosing.

This kind of carrier will ease the control burden on the Pcell by enabling the downlink control region on this new type of carrier; and also maintain the advantage of a pure extension carrier by disabling its downlink control region. For example, when there are a high number of UEs which are low data volume users the network can enable the configurable DL control region in this new type of CC and schedule UEs on that new CC from its own enabled DL control region. At other times when higher data rates are needed to serve a fewer total number of UEs (or if some UEs are particularly high data volume users) the DL control region on this new CC can be disabled and the symbol positions which are no longer reserved for DL control signaling can be used for user data which is cross-scheduled from the Pcell or from some other CC. Advantageously, the DL control region for this new type of CC can be switched on-the-fly between enabled and disabled to enable the network to effectively manage its traffic.

To distinguish this new CC having a configurable DL control region from other CCs, such a new CC is referred to herein as a C-DCR carrier. The description below assumes that radio resources on the C-DCR carrier are cross-scheduled on the Pcell since for CA cross-scheduling in general this is expected to be typical, but cross-scheduling may be from any configured and activated Scell without departing from these teachings. Further, the description is in the context of the LTE and LTE-A systems in order to present specific and practical examples, but these teachings may readily be applied to other CA wireless systems apart from only E-UTRAN.

Such a C-DCR is particularly suitable for LTE when operated on an unlicensed band such as TV white spaces or ISM. So long as the unlicensed band is reliable enough for the network operator's traffic needs, the downlink control region could be enabled to decrease the control burden on the Pcell. And if the operator finds the unlicensed band at which the C-DCR is located is too crowded or otherwise unreliable, the network can disable the downlink control region and port downlink controls to other CCs in the licensed band, or to another C-DCR carrier in the unlicensed band. The network can also cross-schedule UEs on the C-DCR carrier with the disabled C-DCR if other non-DCR portions of that C-DCR carrier in the unlicensed band remain reliable, and this cross scheduling can be either from the Pcell or from another C-DCR carrier whose C-DCR is enabled. But the inventors anticipate that the control signaling overhead burden can become worse in the latter case in which resources on an unlicensed band C-DCR carrier with a disabled C-DCR are scheduled from a different unlicensed band C-DCR carrier with an enabled C-DCR.

In an exemplary embodiment of the invention there is a C-DCR carrier for which its downlink control region, the symbols that are reserved for downlink control channels, are dynamically enabled and disabled. The C-DCR is configured and changed (between enabled and disabled) via high layer signaling. In this embodiment the C-DCR carrier in a CA system should only be configured as a Scell. In one exemplary embodiment this C-DCR and its carrier lay in the licensed band. In another exemplary embodiment to obtain the advantages noted in the above paragraph the C-DCR and its carrier lay in the unlicensed band.

Specific for LTE-related implementation, when the C-DCR is enabled on the carrier, the downlink control region is configured with 1 to 4 symbols. The advantage of this embodiment is that it would be backward-compatible with the conventional carriers in Release 10. The configuration and status (enabled or disabled) is given by a value of a control field indication CIF sent in RRC signaling. When the downlink control region is disabled on the C-DCR carrier, no symbol or symbols are reserved for any downlink control channel, which for LTE and LTE-A includes PCFICH, PDCCH and PHICH. Since no symbols are reserved for DL control channels while the C-DCR is disabled, the downlink data channel PDSCH will cover all symbols in all subframes, which in LTE currently is symbol#0 to #13 for a normal CP and symbol#0 to #11 for an extended CP.

Switching between enabled and disabled for the C-DCR requires some signaling support, to inform the UEs where to look for their PDCCHs which schedule them on UL and DL radio resources. The current Release 10 CA signaling regimen does not support a configurable downlink control region.

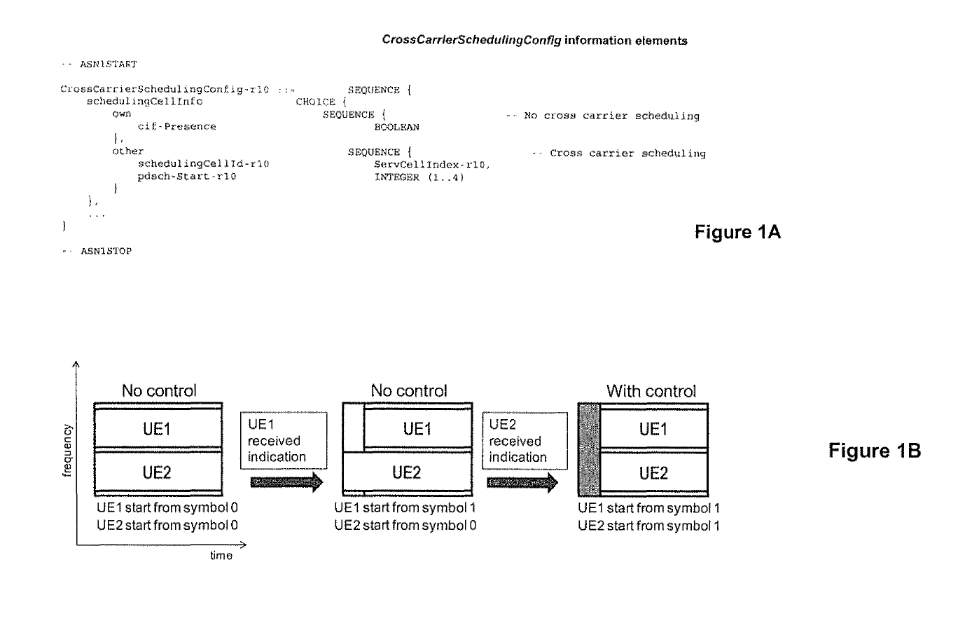

Specifically, the Release 10 protocol utilizes RRC signaling to indicate a control field indication (CFI) value on an Scell, but this value cannot set to 0 and therefore could not be used to disable a downlink control region on an Scell completely. The relevant signaling already supported by Release 10 specifications is a cross carrier scheduling configuration information element, set forth at page 157 of 3GPP TS 36.331 V10.0.0, RADIO RESOURCE CONTROL (2010.12) and reproduced at FIG. 1A. The parameter pdsch-Start-r10 is used to indicate the PDSCH starting position on the Scell, and the value range is from 1 to 4 indicating symbol#1 to symbol#4. Therefore in all cases the Scell has at least one symbol reserved for its downlink control region, and the downlink control region could not be disabled completely by using this conventional signaling.

If one were simply to add CFI value 0 into this field of the information element of FIG. 1A the result would not be very useful. This is because the RRC signaling represented by FIG. 1A is UE-specific signaling, whereas the status of the configurable downlink control region being enabled or disabled is cell-specific. This means that if one were to enable and disable the C-DCR as a whole utilizing UE-specific RRC signaling there would be large configuration delays and hence wasted radio resources. For example, if the access node/eNB chooses to configure the downlink control region on an unlicensed band carrier, the eNB would need to send such RRC signaling to each UE and the eNB cannot utilize this downlink control region for control signaling on the cell until the last UE sends its RRC configuration complete message back to eNB in reply.

FIG. 1B illustrates this problem. At the left-most panel the C-DCR carrier begins with its C-DCR disabled which both UE1 and UE2 recognize. The eNB sends in the center panel the cross carrier scheduling configuration information element in RRC signaling to the UE1 to enable the C-DCR, to which UE1 responds with its RRC configuration complete message and at symbol position #1 begins to look for a PDCCH with the identification of UE1 in the enabled C-DCR. UE2 still considers the C-DCR carrier to have a disabled C-DCR in the center panel. In the right-most panel of FIG. 1B the eNB sends the cross carrier scheduling configuration information element in RRC signaling to the UE2 to enable the C-DCR, to which UE2 responds with its RRC configuration complete message. UE2 also begins looking for its PDCCH in the enabled C-DCR at symbol position #1. In the meantime symbol position #0 goes unused, since neither UE1 nor UE2 are looking for their PDCCH until the next symbol position and the eNB cannot effectively schedule until all UEs in the affected cell have acknowledged (via their RRC configuration complete message) that the C-DCR is now enabled. Similar delay, wasting of radio resources, unnecessary blind decoding for UEs and large signaling overhead occurs when the eNB also changes the C-DCR from enabled to disabled if the signaling were simply expanding the allowable CFI values to include zero since still the same UE-specific RRC signaling is used.

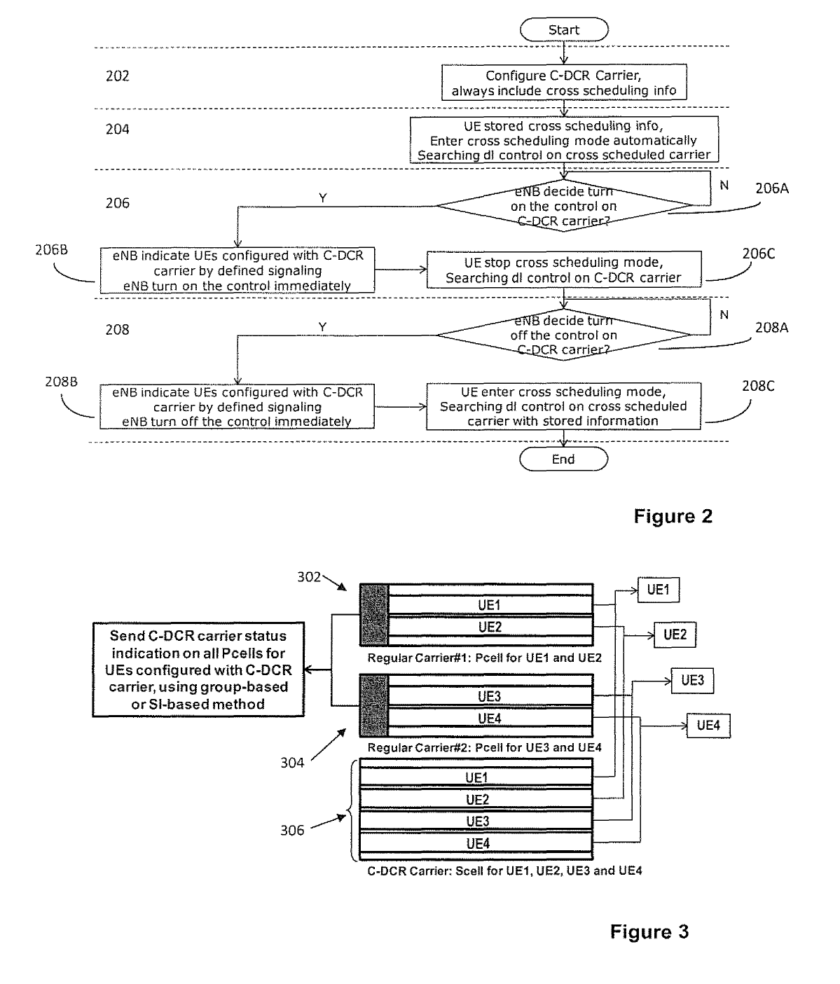

Before detailing various more efficient ways for the network to signal that the C-DCR on the C-DCR carrier is enabled or disabled, FIG. 2 presents an overview of actions by the eNB and by the UE when the C-DCR is changed between enabled and disabled, regardless of how it may be signaled. At block 202 the eNB configures the C-DCR carrier, which may be an initial configuration such as for a UE's initially configured set of CCs. For the initial configuration (Scell configuration) of the C-DCR carrier, block 202 provides that the eNB always includes cross scheduling information in the signaling and indicates to the UE explicitly of the C-DCR carrier type. The cross scheduling information tells the UE at least which carrier will carry the scheduling grants (PDCCH) for radio resources on the C-DCR carrier, if the C-DCR carrier is to be cross scheduled. The DL control region on the C-DCR carrier is turned off/disabled by default in this embodiment, so merely indicating that the carrier is a C-DCR carrier without additionally indicating its C-DCR is enabled will inform the UE that the C-DCR on that carrier is disabled. At block 204 the UE stores in its local memory the corresponding cross scheduling information, and turns to the cross scheduling mode automatically since the UE knows the C-DCR is disabled.

Section 206 of FIG. 2 illustrates switching the C-DCR from disabled to enabled. When the eNB decides to turn on/enable the DL control region on the C-DCR carrier at block 206A, the eNB will indicate to the UE the corresponding status change at block 206B. This indication may by example follow the group-signaling techniques detailed below, which allows the eNB to turn on/enable the C-DCR and begin utilizing it immediately as block 206B recites for sending DL control signals such as resource allocations/scheduling tables. Upon receiving this signaled status change indication, the UE at block 206C will stop its cross scheduling mode from block 204 and begin searching the DL control on the C-DCR carrier which is now enabled.

Section 208 of FIG. 2 illustrates switching the C-DCR from enabled back to disabled. When the eNB decides to turn off/disable the DL control region on the C-DCR carrier at block 208A, the eNB will indicate to the UE the corresponding status change at block 2083. This indication may also by example follow the group-signaling techniques detailed below, and block 208B recites that the eNB can turn off/disable the C-DCR immediately and begin utilizing all symbol positions within the C-DCR carrier for data as cross-scheduled by another CC (e.g., each UE's Pcell). Upon receiving this signaled status change indication, the UE at block 208C will enter the cross scheduling mode with the stored cross scheduling information, and begin searching the DL control on the cross-scheduling carrier (e.g., the Pcell).

To avoid the delay and wasted resources detailed above with respect to FIG. 1B, the signaling at blocks 206B and 208B of FIG. 2 is in an exemplary embodiment a group-based signaling to a plurality of UEs to indicate to them all the downlink control region status change between disabled and enabled of the C-DCR carrier. Such group-based signaling may also be used in this embodiment to indicate to the UEs the configuration of the C-DCR carrier at block 202 of FIG. 2, which identifies which if any carriers are C-DCR carriers. Below are two exemplary but non-limiting examples of such group-based signaling.

In one implementation the group based signaling is an SIB message which the eNB broadcasts in all the CCs which are in use as a Pcell to indicate to a group of UEs the status change of the downlink control region (disabled to enabled or vice versa) of the downlink control region on the C-DCR carrier. Such an SIB may be implemented by adding one SIB information element to a conventional SIB message, in which this added information element includes the downlink frequency and downlink control region status of the C-DCR so as to indicate to those UEs who have been configured with this C-DCR carrier of the C-DCR's status. Alternatively, such an SIB message with this new information element may be broadcast only on the Pcells of UEs which are configured with a C-DCR carrier.

In an alternative implementation the group based signaling utilizes a group RNTI which identifies a plurality of UEs. In this implementation the eNB creates a new group RNTI and uses group scheduling to indicate to the entire group of UEs the status change (disabled to enabled or vice versa) of the downlink control region on the C-DCR carrier. In one embodiment the network reserves an RNTI value for this purpose, and sends the indication of the C-DCR status change in a MAC CE which the eNB transmits in the PDSCH, the PDSCH being scheduled by a PDCCH and scrambled with this reserved group RNTI in the UE's Pcell. In another embodiment the eNB performs this group scheduling on all Pcells of UEs which are configured with C-DCR carrier whose status is being changed. In this case the eNB schedules the indication of C-DCR carrier status change for UEs using the PDCCH as scrambled by this reserved group RNTI.

For any of these group-based signaling embodiments, the different UEs may be configured with different Pcells, and the group-RNTI based or SI based C-DCR carrier status indication needs to be sent on all Pcells of UEs that are configured with the C-DCR carrier whose status is being changed, which FIG. 3 illustrates by example. Assume the four UEs illustrated thee, UE1, UE2, UE3 and UE4, are each configured with the C-DCR carrier 306 which is a Scell for each of them. UE1 and UE2 are configured with CC#1 (reference number 302) as their Pcell whereas UE3 and UE4 are configured with CC#2 (reference number 304) as their Pcell. Either of the group-based signaling techniques noted above can be sent on CC#1 and CC#2 to inform all four UEs that the status of the C-DCR on the S-DCR carrier 306 is changed. As noted above, the eNB may, in an exemplary embodiment of the SIB group signaling technique, include the new information element in broadcasts on all of the Pcells, without regard to which UE being configured with a C-DCR carrier is configured with which Pcell.

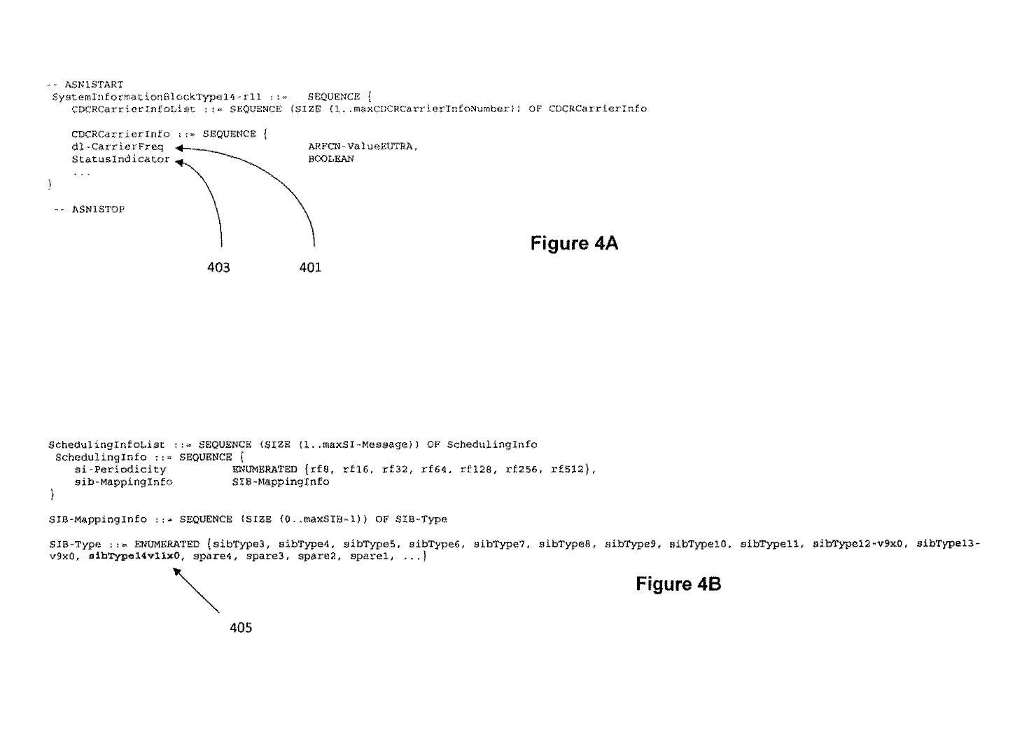

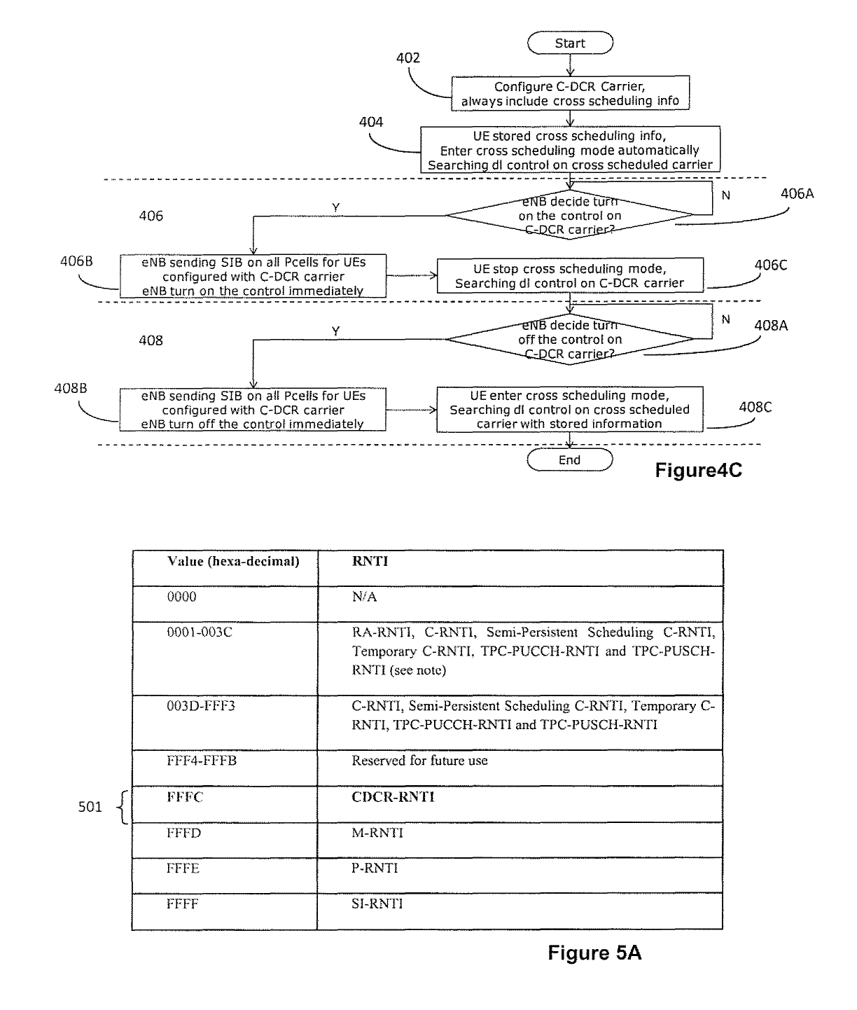

For the SIB group signaling embodiments, FIG. 4A illustrates one possible form that new information element might take. There is a dl-CarrierFreq field 401 to indicate exactly the C-DCR carrier, and there is also a StatusIndicator field 403 is to indicate to the UE the downlink control region status of the C-DCR carrier identified by the dl-CarrierFreq field 401. For example, when the value of the Statuslndicator field 403 is zero, the downlink control region of the C-DCR carrier identified in field 401 is disabled. Otherwise the downlink control region of C-DCR carrier is enabled. FIG. 4B shows an exemplary addition to scheduling information for the new SIB in SIB-1, in which a new SIB type is defined sibType14v11x0 as shown by reference number 405.

FIG. 4C is similar to FIG. 2 but specifically utilizing the broadcast system information to indicate the status change for enabling and disabling the C-DCR.

Blocks 402, 404, 406A, 406C, 408A and 408C of FIG. 4 are identical to respective blocks 202, 204, 206A, 206C, 208A and 208C of FIG. 2, and so are not detailed again. Blocks 406B and 408B of FIG. 4 specify that the eNB uses a SIB for the group-based signaling to the plurality of UEs that the C-DCR is turned on/enabled and turned off/disabled. By example the SIB of blocks 406B and 408B carries the information element detailed at FIG. 4A.

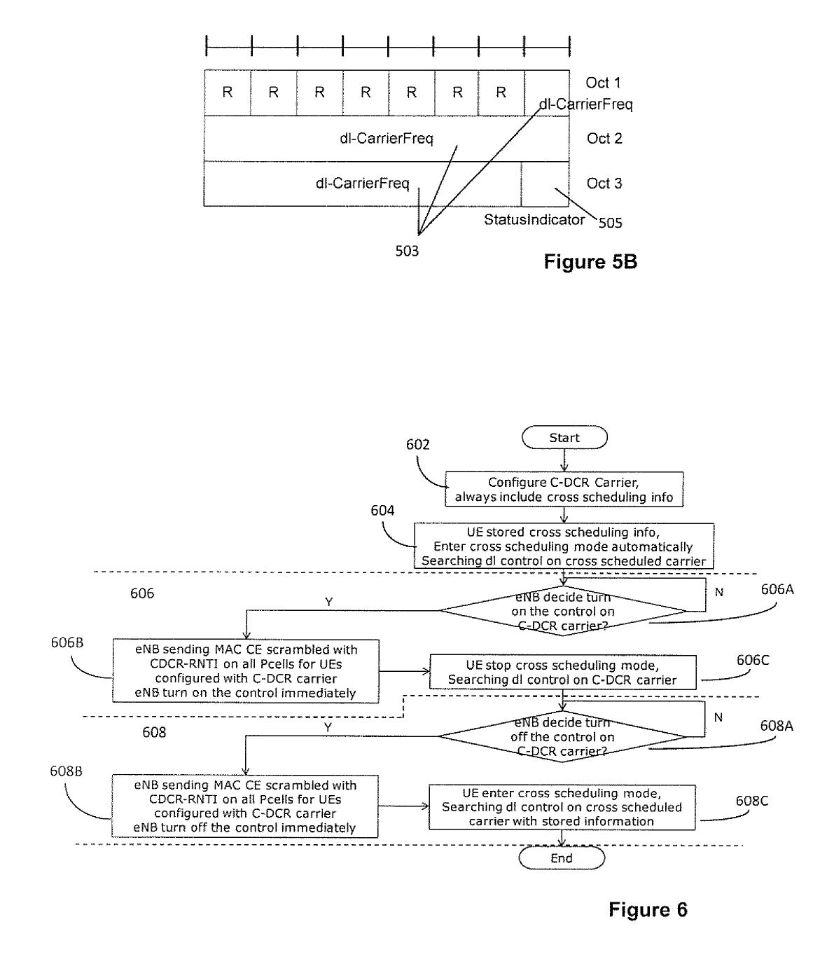

For the group-RNTI signaling embodiments, FIG. 5A illustrates the RNTI (hexa-decimal) value at reference number 501 which is reserved for the CDCR-RNTI group of UEs. All UEs which are configured with a C-DCR carrier are members of this group and will, in each DL subframe, try to decode any PDCCH which is scrambled with that CDCR-RNTI. One specific embodiment of the new MAC CE for the group-RNTI signaling embodiment is shown at FIG. 5B which contains the C-DCR carrier information, such as downlink frequency and downlink control indicator. The three-byte CE is byte aligned, and so the DL carrier frequency information 503 is illustrated in the specific FIG. 5B embodiment as 16 bits which are spread across three octets/bytes. The DL control/status indicator 505 is only a single bit since in this embodiment it simply indicates enabled or disabled for the C-DCR.

Note that the related cross scheduling information in this embodiment is not in the MAC CE which itself changes the C-DCR status; the UE will use the cross scheduling information which the eNB signaled when the C-DCR carrier was first configured for the UE, which was detailed above at block 202 of FIG. 2.

FIG. 6 is similar to FIG. 2 but specifically utilizing the group-RNTI and MAC CE technique of FIGS. 5A-B to indicate the status change for enabling and disabling the C-DCR. Blocks 602, 604, 606A, 606C, 608A and 608C of FIG. 6 are identical to respective blocks 202, 204, 206A, 206C, 208A and 208C of FIG. 2, and so are not detailed again. Blocks 606B and 608B of FIG. 6 specify that the eNB uses the MAC CE scrambled with the reserved CDCR-RNTI for the group-based signaling to the plurality of UEs that the C-DCR is turned on/enabled and turned off/disabled. By example the CDCR-RNTI scrambling the MAC CE of blocks 606B and 608B are those detailed at FIGS. 5A-B respectively and carries the DL carrier frequency information 503 and the C-DCR status indicator 505 as detailed there.

Exemplary embodiments of these teachings exhibit the technical effect of decreasing the downlink control burden for the serving cell (as compared to a carrier with no DCR) which enables cross scheduling. Another technical effect is that the C-DCR carrier is suitable for LTE operated on unlicensed band, and that the downlink control region can be disabled or enabled on-the-fly. Embodiments of the C-DCR carrier detailed herein are more flexible than either a backward-compatible carrier or a simple (non C-DCR configurable) extension carrier. The group-based signaling methods detailed herein supports the downlink control region status change on the C-DCR carrier in a more efficient way than a simple extension of conventional LTE signaling, which offers the technical effect of greatly decreasing the configuration delay and the waste of radio resources. While the advantage in control signaling overhead from these techniques over UE-specific RRC signaling are less pronounced when there are few UEs configured with the C-DCR carrier, it appears that in every practical case there is improved efficiency from the group-wise signaling of status change as compared to UE-specific RRC signaling.

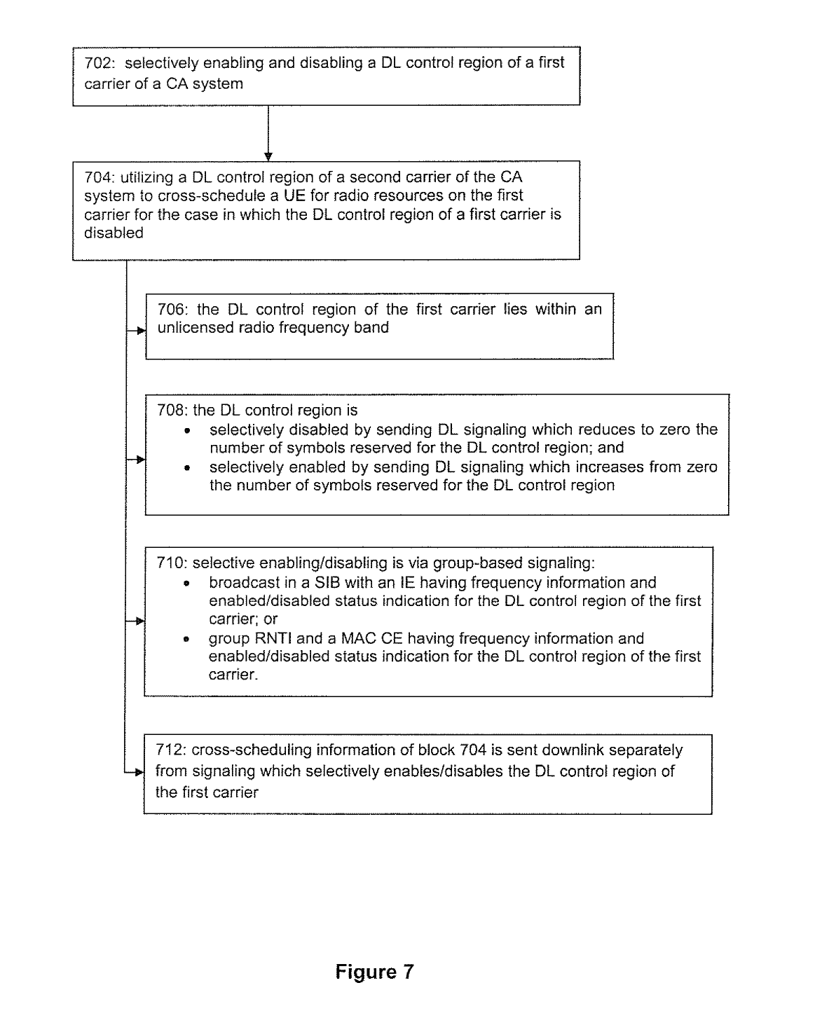

FIG. 7 is a logic flow diagram which describes an exemplary embodiment of the invention in a manner which may be from the perspective of the UE or from the eNB. FIG. 7 may be considered to illustrate the operation of a method, and a result of execution of a computer program stored in a computer readable memory, and a specific manner in which components of an electronic device are configured to cause that electronic device to operate. The various blocks shown in FIG. 7 may also be considered as a plurality of coupled logic circuit elements constructed to carry out the associated function(s), or specific result of strings of computer program code stored in a memory.

Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

At block 702 a downlink control region of a first carrier of a carrier aggregation system is selectively enabled and disabled. At block 704, for the case in which the downlink control region of the first carrier is disabled, a downlink control region of a second carrier of the carrier aggregation system is utilized to cross-schedule a user equipment for radio resources on the first carrier.

The remainder of FIG. 7 illustrates more specific implementations for blocks 702 and 704. Block 706 specifies that at least the downlink control region of the first carrier lays within an unlicensed radio frequency band, such as for example TV white spaces or the ISM band. In another embodiment not specifically reflected at FIG. 7 the C-DCR is in the licensed band. At block 708, the downlink control region is selectively disabled by the eNB sending downlink signaling which reduces to zero a number of symbols reserved for the downlink control region; and it is selectively enabled by the eNB sending downlink signaling which increases from zero a number of symbols reserved for the downlink control region. The UEs understand the C-DCR status indication to change the reserved symbols to zero and non-zero as detailed above, and the eNB may send explicit signaling indicating just how many symbols are reserved for the C-DCR for the case it is enabled.

Block 710 specifies the two group-based signaling options detailed above for indicating the enabling and disabling of the C-DCR. In one option this signaling is broadcast in a SIB comprising an IE which itself includes frequency information of the downlink control region of the first carrier and a status indication having a value indicating whether the downlink control region of the first carrier is currently enabled or disabled. In the other option this signaling is a group RNTI which identifies the plurality of user equipments and a MAC CE which itself includes frequency information of the downlink control region of the first carrier and a status indication having a value indicating whether the downlink control region of the first carrier is currently enabled or disabled.

Block 712 illustrates the FIG. 2 embodiment in which the cross-scheduling information for block 704 is sent downlink separately from signaling which selectively enables/disables the DL control region of the first carrier.

FIG. 7 may be considered to reflect a modem which may be apart from or disposed in the eNB of the above description and further detailed below.

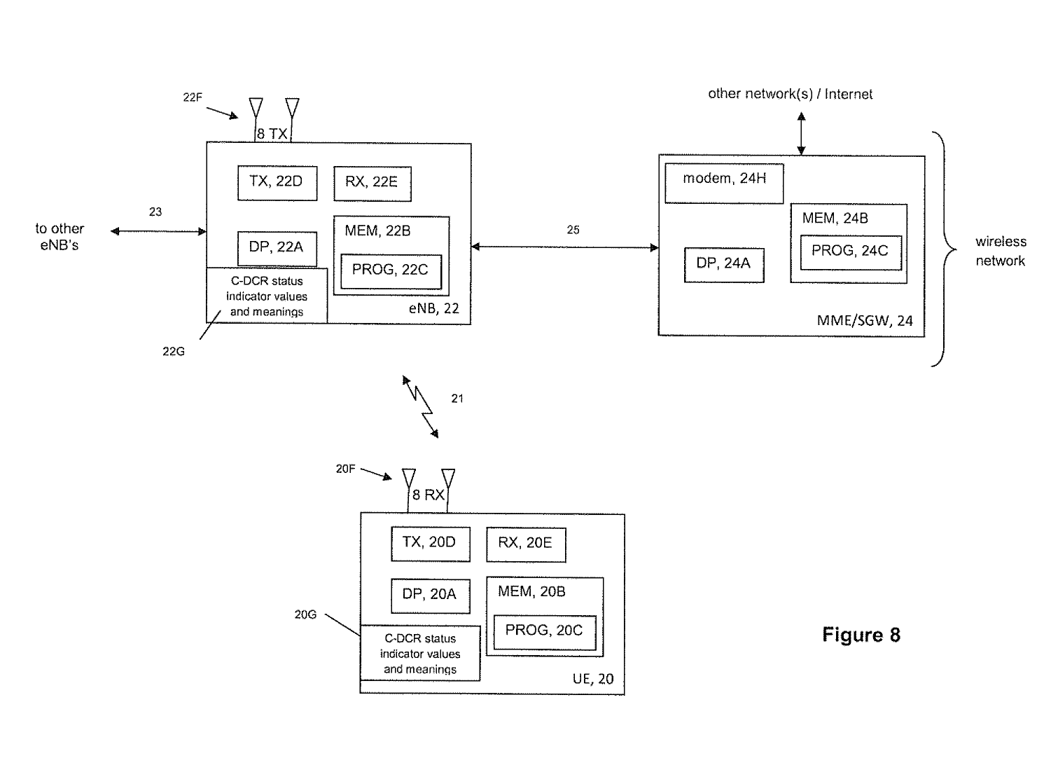

Reference is now made to FIG. 8 for illustrating a simplified block diagram of various electronic devices and apparatus that are suitable for use in practicing the exemplary embodiments of this invention. In FIG. 8 a wireless network (eNB 22 and mobility management entity MME/serving gateway SGW 24) is adapted for communication over a wireless link 21 with an apparatus, such as a mobile terminal or UE 20, via a network access node, such as a base or relay station or more specifically an eNB 22. The network may include a network control element MME/SGW 24, which provides connectivity with further networks (e.g., a publicly switched telephone network PSTN and/or a data communications network/Internet).

The UE 20 includes processing means such as at least one data processor (DP) 20A, storing means such as at least one computer-readable memory (MEM) 2013 storing at least one computer program (PROG) 20C, communicating means such as a transmitter TX 20D and a receiver RX 20E for bidirectional wireless communications with the eNB 22 via one or more antennas 20F (8 RX antennas shown but there may be as few as one RX antenna in certain embodiments). Also stored in the MEM 20B at block 20G is a table or listing of the C-DCR status indicator values and their meanings so that the UE can recognize whether signaling enables or disables the C-DCR of the C-DRC carrier and know where to look for its PDCCH which schedules the C-DCR carrier.

The eNB 22 also includes processing means such as at least one data processor (DP) 22A, storing means such as at least one computer-readable memory (MEM) 22B storing at least one computer program (PROG) 22C, and communicating means such as a transmitter TX 22D and a receiver RX 22E for bidirectional wireless communications with the UE 20 via one or more antennas 22F (8 TX antennas shown as in the above examples though these teachings may be utilized with 4 or some other number of TX antennas). There is a data and/or control path 25 coupling the eNB 22 with the MME/SGW 24, and another data and/or control path 23 coupling the eNB 22 to other eNBs/access nodes. The eNB 22 stores at block 22G a similar table or listing of the C-DCR status indicator values and their meanings as well as the current status of the various C-DCR carriers and which UE is assigned them so that the eNB can correctly signal downlink whether the C-DCR on the respective C-DCR carrier is enabled or disabled and know which PDCCH to put allocations for radio resources on the C-DCR carrier.

Similarly, the MME/SGW 24 includes processing means such as at least one data processor (DP) 24A, storing means such as at least one computer-readable memory (MEM) 24B storing at least one computer program (PROG) 24C, and communicating means such as a modem 24H for bidirectional wireless communications with the eNB 22 via the data/control path 25. While not particularly illustrated for the UE 20 or eNB 22, those devices are also assumed to include as part of their wireless communicating means a modem which may be inbuilt on an RF front end chip within those devices 20, 22 and which also carries the TX 20D/22D and the RX 20E/22E.

At least one of the PROGs 20C in the UE 20 is assumed to include program instructions that, when executed by the associated DP 20A, enable the device to operate in accordance with the exemplary embodiments of this invention, as detailed above. The eNB 22 may also have software stored in its MEM 22B to implement certain aspects of these teachings as detailed above. In these regards the exemplary embodiments of this invention may be implemented at least in part by computer software stored on the MEM 20B, 22B which is executable by the DP 20A of the UE 20 and/or by the DP 22A of the eNB 22, or by hardware, or by a combination of tangibly stored software and hardware (and tangibly stored firmware). Electronic devices implementing these aspects of the invention need not be the entire UE 20 or eNB 22, but exemplary embodiments may be implemented by one or more components of same such as the above described tangibly stored software, hardware, firmware and DP, a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEMs 20B and 22B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A and 22A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE Release 10 system, it should be appreciated that the exemplary embodiments of this invention are not limited for use with only this one particular type of wireless communication system, and that they may be used to advantage in other wireless communication systems such as for example UTRAN, GERAN and GSM and others.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1. An apparatus, comprising:
at least one processor; and
at least one memory storing a computer program;
in which the at least one memory with the computer program is configured with the at least one processor to cause the apparatus to at least:
selectively enable and disable a downlink control region of a first carrier of a carrier aggregation system; and
for the case in which the downlink control region of the first carrier is disabled, utilize a downlink control region of a second carrier of the carrier aggregation system to cross-schedule a user equipment for radio resources on the first carrier.

2. The apparatus according to claim 1, in which at least the downlink control region of the first carrier lies within an unlicensed radio frequency band.

3. The apparatus according to claim 1, in which the at least one memory with the computer program is configured with the at least one processor to cause the apparatus to:
selectively disable the downlink control region by sending downlink signaling which reduces to zero a number of symbols reserved for the downlink control region; and
selectively enable the downlink control region by sending downlink signaling which increases from zero a number of symbols reserved for the downlink control region.

4. The apparatus according to claim 3, in which the downlink signaling is a group-based signaling to a plurality of user equipments.

5. The apparatus according to claim 4, in which the group-based signaling is broadcast in a system information block comprising an information element comprising frequency information of the downlink control region of the first carrier and a status indication having a value indicating whether the downlink control region of the first carrier is currently enabled or disabled.

6. The apparatus according to claim 4, in which the group based signaling comprises a group radio network temporary identifier which identifies the plurality of user equipments and a control element comprising frequency information of the downlink control region of the first carrier and a status indication having a value indicating whether the downlink control region of the first carrier is currently enabled or disabled.

7. The apparatus according to claim 1, in which the at least one memory with the computer program is configured with the at least one processor to cause the apparatus to at least:
send cross-scheduling information downlink which indicates that the first carrier will be cross-scheduled from the second carrier when the downlink control region of the first carrier is disabled,
in which the cross scheduling information is sent separately from signaling which selectively enables and which selectively disables the downlink control region of the first carrier.

8. The apparatus according to claim 1, in which the apparatus comprises a modem.

9. A method, comprising:
selectively enabling and disabling a downlink control region of a first carrier of a carrier aggregation system; and
for the case in which the downlink control region of the first carrier is disabled, utilizing a downlink control region of a second carrier of the carrier aggregation system to cross-schedule a user equipment for radio resources on the first carrier.

10. The method according to claim 9, in which at least the downlink control region of the first carrier lies within an unlicensed radio frequency band.

11. The method according to claim 9, in which:
selectively disabling the downlink control region comprises sending downlink signaling which reduces to zero a number of symbols reserved for the downlink control region; and
selectively enabling the downlink control region comprises sending downlink signaling which increases from zero a number of symbols reserved for the downlink control region.

12. The method according to claim 11, in which the downlink signaling is a group-based signaling to a plurality of user equipments.

13. The method according to claim 12, in which the group-based signaling is broadcast in a system information block comprising an information element comprising frequency information of the downlink control region of the first carrier and a status indication having a value indicating whether the downlink control region of the first carrier is currently enabled or disabled.

14. The method according to claim 12, in which the group based signaling comprises a group radio network temporary identifier which identifies the plurality of user equipments and a control element comprising frequency information of the downlink control region of the first carrier and a status indication having a value indicating whether the downlink control region of the first carrier is currently enabled or disabled.

15. The method according to claim 9, the method further comprising:
sending cross-scheduling information downlink which indicates that the first carrier will be cross-scheduled from the second carrier when the downlink control region of the first carrier is disabled,
in which the cross scheduling information is sent separately from signaling which selectively enables and which selectively disables the downlink control region of the first carrier.

16. The method according to claim 9, in which the method is executed by an access node of the carrier aggregation system.

17. A computer readable memory storing a computer program comprising:
code for selectively enabling and disabling a downlink control region of a first carrier of a carrier aggregation system; and
code for utilizing a downlink control region of a second carrier of the carrier aggregation system to cross-schedule a user equipment for radio resources on the first carrier for the case in which the downlink control region of the first carrier is disabled.

18. The computer readable memory according to claim 17, in which at least the downlink control region of the first carrier lies within an unlicensed radio frequency band.

19. The computer readable memory according to claim 17, in which the downlink control region is selectively enabled and disabled via group-based signaling broadcast in a system information block comprising an information element comprising frequency information of the downlink control region of the first carrier and a status indication having a value indicating whether the downlink control region of the first carrier is currently enabled or disabled.

20. The computer readable memory according to claim 17, in which the downlink control region is selectively enabled and disabled via group-based signaling to a plurality of user equipments, the group-based signaling comprising a group radio network temporary identifier which identifies the plurality of user equipments and a control element comprising frequency information of the downlink control region of the first carrier and a status indication having a value indicating whether the downlink control region of the first carrier is currently enabled or disabled.
